(19) United States
(12) Patent Application Publication
(10) Pub. No.: US 2018/0165174 A1
(43) Pub. Date: Jun. 14, 2018

(54) MESSAGE ANALYSIS APPARATUS, MESSAGE ANALYSIS METHOD, AND STORAGE MEDIUM

(71) Applicants: NEC Corporation, Minato-ku, Tokyo (JP); NEC Solution Innovators, Ltd., Koto-ku, Tokyo (JP)

(72) Inventors: Yasuhiro AJIRO, Tokyo (JP); Shinichi TORIYAMA, Tokyo (JP); Kazuya FUJITA, Tokyo (JP)

(73) Assignees: NEC Corporation, Minato-ku, Tokyo (JP); NEC Solution Innovators, Ltd., Koto-ku, Tokyo (JP)

(21) Appl. No.: 15/577,839

(22) PCT Filed: Jun. 10, 2016
(86) PCT No.: PCT/JP2016/002816

§ 371 Date: Nov. 29, 2017

(30) Foreign Application Priority Data
Jun. 11, 2015 (JP) 2015-118217

(51) Int. Cl. G06F 11/34; G06K 9/62; G06Q 50/00

(52) U.S. Cl. CPC G06F 11/3476; G06Q 50/01; G06K 9/6218; G06F 11/3438

(57) ABSTRACT

The present invention can provide a technology for presenting information that indicates contents and trends of many messages without a need to define a portion that varies among the messages in advance. A message analysis apparatus is provided with a clustering unit, a field analysis unit, and a pattern generation unit. The clustering unit classifies a message set that is an aggregation of messages each being formed of one or more fields, into a cluster, based on similarity among the messages. The field analysis unit identifies, in each of fields that form a message group in the cluster, a variable portion in which a value in the field varies and an invariable portion in which a value in the field does not vary. The pattern generation unit generates a message pattern being common to the message group in the cluster, based on the variable portion and the invariable portion.

### TECHNICAL FIELD

The present invention relates to a technology for analyzing many messages.

### BACKGROUND ART

In an apparatus or a service, a large quantity of messages called as a log are generally recorded as a history of an operating status or an utilization status thereof. In a social networking service or the like on the Internet, messages are input by many users and recorded. An analyzer who analyzes such many messages needs to grasp contents and trends of information included in the large quantity of messages.

An example of a technology for analyzing a message is described in PTL 1. The related technology described in PTL 1 extracts a common portion being common to other messages and a different portion being different from other messages, from messages included in a log. This related technology then provides identification information for the extracted common portion and stores the extracted common portion as common portion information. The related technology provides identification information for the extracted different portion and stores the extracted different portion as different portion information. This related technology stores each message by associating the identification information of the common portion with the identification information of the different portion. With this related technology, an analyzer of messages can grasp the common portion and the different portion in the large quantity of messages.

### CITATION LIST

### Patent Literature

[PTL 1] International Patent Publication No. WO2013/136418

### SUMMARY OF INVENTION

### Technical Problem

However, the related technology described in PTL 1 needs to define a variable that forms the different portion in order to extract the common portion and the different portion. For example, a digit sequence having one or more characters is defined as a variable indicating a process ID, concerning a message included in a log as an operating record of an operating system. Furthermore, a digit sequence separated by periods is defined as a variable indicating an Internet Protocol (IP) address. This related technology then extracts a portion that matches a definition of a variable among messages as a different portion, and extracts other portions as a common portion. In this way, this related technology cannot extract the common portion and the different portion of a large quantity of messages unless a variable is defined in advance. Thus, the related technology cannot present information that indicates contents and trends of the messages.

The present invention is to solve the above-mentioned problems. In other words, an object of the present invention is to provide a technology for presenting information that indicates contents and trends of many messages without a need to define a portion that varies among the messages in advance.

### Solution to Problem

To achieve the above object, a message analysis apparatus of the present invention includes: clustering means that classifies a message set that is an aggregation of messages each being formed of one or more fields, into a cluster, based on similarity among the messages; field analysis means that identifies, in each of fields that form a message group in the cluster, a variable portion in which a value in the field varies and an invariable portion in which a value in the field does not vary; and pattern generation means that generates a message pattern being common to the message group in the cluster, based on the variable portion and the invariable portion.

A message analysis method of the present invention utilize a computer device. The method includes: classifying a message set that is an aggregation of messages each being formed of one or more fields, into a cluster, based on similarity among the messages; identifying, in each of fields that form a message group in the cluster, a variable portion in which a value in the field varies and an invariable portion in which a value in the field does not vary; and generating a message pattern being common to the message group in the cluster, based on the variable portion and the invariable portion.

A storage medium of the present invention stores a message analysis program causing a computer device to execute. The storage medium includes: a clustering step of classifying a message set that is an aggregation of messages each being formed of one or more fields, into a cluster, based on similarity among the messages; a field analysis step of identifying, in each of fields that form a message group in the cluster, a variable portion in which a value in the field varies and an invariable portion in which a value in the field does not vary; and a pattern generation step of generating a message pattern being common to the message group in the cluster, based on the variable portion and the invariable portion.

A program may be stored in a non-transitory recording medium.

### Advantageous Effects of Invention

The present invention can provide a technology for presenting information that indicates contents and trends of many messages without a need to define a portion that varies among the messages in advance.

### BRIEF DESCRIPTION OF DRAWINGS

FIG. 1 is a block diagram illustrating a configuration of a message analysis apparatus according to a first example embodiment of the present invention.

FIG. 2 is a diagram illustrating an example of a hardware configuration of the message analysis apparatus according to the first example embodiment of the present invention.

FIG. 3 is a flowchart for describing operations of the message analysis apparatus according to the first example embodiment of the present invention.

FIG. 4 is a block diagram illustrating a configuration of a message analysis apparatus according to a second example embodiment of the present invention.

FIG. 5 is a flowchart for describing operations of the message analysis apparatus according to the second example embodiment of the present invention.

FIG. 6 is a diagram illustrating a specific example of a clustering result in the second example embodiment of the present invention.

FIG. 7 is a diagram illustrating a specific example of a field analytical result in the second example embodiment of the present invention.

FIG. 8 is a block diagram illustrating a configuration of a message analysis apparatus according to a third example embodiment of the present invention.

FIG. 9 is a flowchart for describing operations of the message analysis apparatus according to the third example embodiment of the present invention.

FIG. 10 is a diagram illustrating a specific example of clusters fragmented in the third example embodiment of the present invention.

FIG. 11 is a block diagram illustrating a configuration of a message analysis apparatus according to a fourth example embodiment of the present invention.

FIG. 12 is a flowchart for describing operations of the message analysis apparatus according to the fourth example embodiment of the present invention.

FIG. 13 is a diagram illustrating a specific example of a field analytical result in the fourth example embodiment of the present invention.

FIG. 14 is a diagram for schematically describing presence or absence of correlations among fields in the fourth example embodiment of the present invention.

FIG. 15 is a diagram illustrating a specific example of clusters fragmented in the fourth example embodiment of the present invention.

### DESCRIPTION OF EMBODIMENTS

Hereinafter, example embodiments of the present invention will be described in detail with reference to the drawings.

### First Example Embodiment

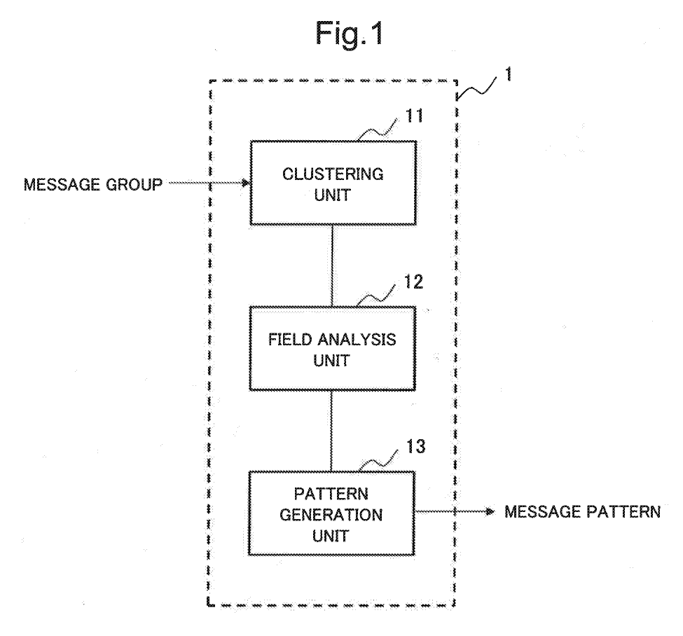

FIG. 1 illustrates a functional block configuration of a message analysis apparatus 1 according to a first example embodiment of the present invention. In FIG. 1, the message analysis apparatus 1 includes a clustering unit 11, a field analysis unit 12, and a pattern generation unit 13. The message analysis apparatus 1 is an apparatus that analyzes a message group and generates a message pattern indicating contents and trends of the message group.

Herein, a message represents a unit of information recorded by an apparatus, a service, a person, or the like. For example, the message may be a unit of information included in log data that indicate history of operating status or utilization status of an apparatus, a service, or the like. In this case, the message may be information in a unit that is generated at every predetermined timing by structural components of an information technology (IT) system such as a server and a client and is added to log data. In this case, the message often includes time at which the message is output, a name of an output source, or the like. Also in this case, the message is often text data of one line included in a file that indicates log data. However, one message may include a plurality of lines. Alternatively, a plurality of messages may be included in one line. For example, it may be assumed that pre-processing of converting a line feed code included in one message that includes a plurality of lines into a space character, pre-processing of converting a space character between a plurality of messages included in one line into a line feed code, or the like is performed on a file that indicates log data. In this case, it can be considered that the message is formed of one line in the file that indicates the log data.

In addition, the message is not limited to information included in log data, and the message may be a unit of information that is input to an arbitrary service via an input device or a network and recorded.

Furthermore, the message is formed of one or more fields. For example, the field may be information divided by a separator. For example, a message of “April 1 13:31:52 logging start” is formed of five fields of “April”, “1”, “13:31:52”, “logging”, and “start” with spaces as separators. Alternatively, there is a message that is not divided by a separator such as a space, like a message composed in Japanese. It can be considered that such a message is formed of one or more fields by pre-processing of separating the message by words, morphemes, and types of characters such as katakana, hiragana, and kanji.

In other words, the assumption that the message in the present example embodiment is formed of one or more fields does not limit types of messages that can be processed in the present example embodiment. Any type of message can be processed as a message formed of one or more fields by performing pre-processing as necessary.

Processing of dividing one field into a plurality of fields is also considered as pre-processing on a message. For example, it is assumed that a value in one field is “abc&def” in one message and “abc&ghi” in the other message. It is also assumed that abc, def, and ghi are defined to each indicate an individual target for contents of a message. In such a case, “abc&def” is suitable to be processed as three fields like “abc”, “&”, and “def” instead of one field. Pre-processing on a message may include such processing.

In the present example embodiment, it is assumed that an aggregation of messages each formed of one or more fields subjected to the above-described pre-processing as necessary (a targeted message set) is input to the message analysis apparatus 1. For example, the target message set may be stored as information in which values (such as character strings, numerical values, symbols, etc.) in fields of each message are expressed in tabular form in a storage device in advance.

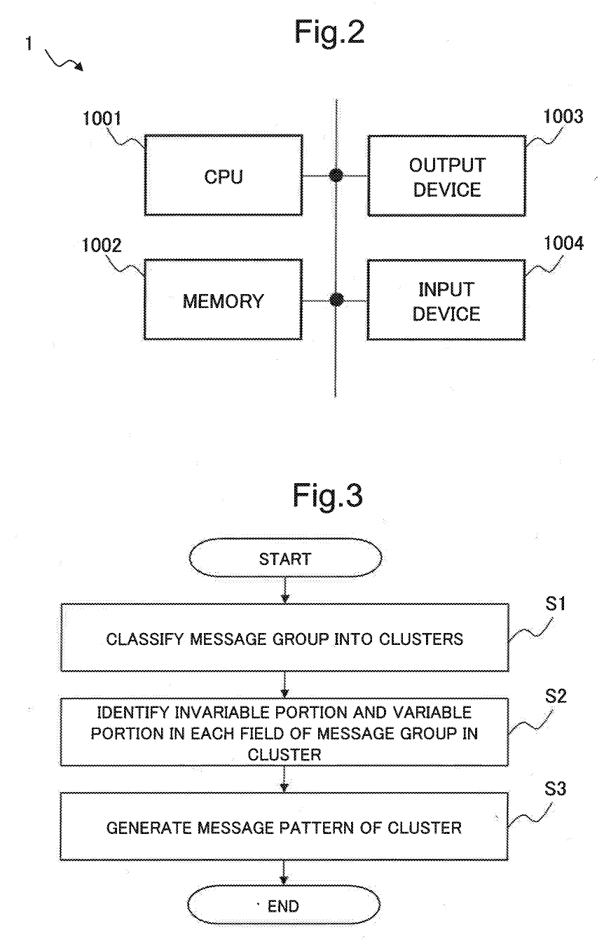

Next, FIG. 2 illustrates an example of a hardware configuration of the message analysis apparatus 1. In FIG. 2, the message analysis apparatus 1 includes a central processing unit (CPU) 1001, a memory 1002, an output device 1003, and an input device 1004. The memory 1002 is formed of a random access memory (RAM), a read only memory (ROM), an auxiliary storage device (such as a hard disk), or the like. The output device 1003 is formed by a device that outputs information, such as a display device and a printer. The input device 1004 is formed by a device that receives an input of a user operation, such as a keyboard and a mouse. In this case, each of functional blocks of the message analysis apparatus 1 is formed by the CPU 1001. The CPU 1001 controls each unit of the output device 1003 and the input device 1004 while reading and executing a computer program stored in the memory 1002. Note that hardware configurations of the message analysis apparatus 1 and each of the functional blocks are not limited to the above-described configuration.

Next, each of the functional blocks of the message analysis apparatus 1 is described in detail.

The clustering unit 11 classifies a targeted message set into clusters, based on similarity among messages. The number of clusters is less than or equal to the number of messages. Note that the targeted message set is an aggregation of messages and each of the message is formed of one or more fields subjected to pre-processing as necessary, as described above. For example, the clustering unit 11 may acquire a target message set stored in the memory 1002 in advance and classify the target message set into clusters. A well-known technology may be adopted as a technique for classifying a plurality of pieces of information, based on similarity among them.

The field analysis unit 12 identifies, in each of fields that form a message group in a cluster, a variable portion in which a value in the field varies and an invariable portion in which a value therein does not vary. Specifically, the field analysis unit 12 may identify a field having same value in all messages in a cluster as an invariable portion. The field analysis unit 12 may identify a field having a different value in at least any of all messages in a cluster as a variable portion.

The pattern generation unit 13 generates a message pattern common to the message group in the cluster, based on the variable portion and the invariable portion of the field. For example, the pattern generation unit 13 may generate, as a common pattern, information in which information that expresses a field being the variable portion by a predetermined symbol (for example, an asterisk “*”) and information that expresses a field being the invariable portion by its value, arranged in an appearing order of the fields. The pattern generation unit 13 then extracts a list of the values on which the fields as the variable portions take in the message group included in the cluster. Hereinafter, a field identified as a variable portion is referred to as a variable, and a value on which the variable may take is referred to as an argument. The pattern generation unit 13 may then generate the common pattern and the argument list of each of the variables as a message pattern for each of the clusters.

Operations of the message analysis apparatus 1 having the configuration as described above are described with reference to FIG. 3.

First, the clustering unit 11 classifies a target message set into clusters, based on similarity among messages (Step S1).

Next, the field analysis unit 12 identifies, in each of fields that form a message group in each of the clusters generated in Step S1, a variable portion in which a value in the field varies and an invariable portion in which a value therein does not vary (Step S2).

Next, the pattern generation unit 13 generates a message pattern common to the message group in the cluster for each of the clusters, based on the variable portion and the invariable portion (Step S3).

As described above, the pattern generation unit 13 may generate a common pattern and an argument list of a variable as a message pattern.

Then, the message analysis apparatus 1 ends the operations.

Next, advantageous effects of the first example embodiment of the present invention are described.

The message analysis apparatus according to the first example embodiment of the present invention can present information that indicates contents and trends of many messages without a need to define a portion that varies among messages in advance.

The reasons are described as follows. In the present example embodiment, the clustering unit classifies a message group into clusters, based on similarity among messages. The field analysis unit then identifies, in each of fields that form a message group in a cluster, a variable portion in which a value in the field varies and an invariable portion in which a value therein does not vary. The pattern generation unit then generates a message pattern common to the message group in the cluster, based on the variable portion and the invariable portion of the field.

In this way, the present example embodiment can extract a variable portion and an invariable portion without a need to define a portion that varies in a message group. Thus, the present example embodiment can present similar message groups to a user in such a way that an invariable portion and a variable portion among the message groups can be recognized without previously defining a variable. As a result, the user who uses the present example embodiment can more easily grasp contents and trends of a large quantity of message groups.

### Second Example Embodiment

Next, a second example embodiment of the present invention is described in detail with reference to the drawings. Note that the same configurations as those of the first example embodiment of the present invention and steps similarly operating to those thereof are denoted by the same signs in each of the drawings referred in description of the present example embodiment. Their detailed description in the present example embodiment is omitted.

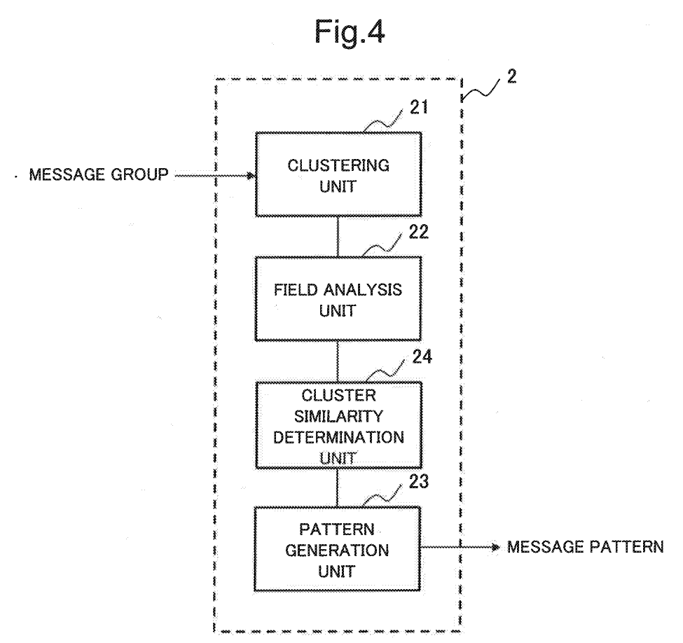

First, FIG. 4 illustrates a functional block configuration of a message analysis apparatus 2 according to the second example embodiment of the present invention. In FIG. 4, the message analysis apparatus 2 differs from the message analysis apparatus 1 according to the first example embodiment of the present invention in following points. In other words, the message analysis apparatus 2 includes a clustering unit 21 instead of the clustering unit 11, a field analysis unit 22 instead of the field analysis unit 12, and a pattern generation unit 23 instead of the pattern generation unit 13. The message analysis apparatus 2 further includes a cluster similarity determination unit 24. Note that the message analysis apparatus 2 and each of functional blocks of the message analysis apparatus 2 can be formed by the same hardware component as that of the first example embodiment of the present invention described with reference to FIG. 2. However, hardware configurations of the message analysis apparatus 2 and each of the functional blocks are not limited to the above-described configuration.

Next, each of the functional blocks of the message analysis apparatus 2 is described in detail.

The clustering unit 21 classifies one message and the other message whose similarity to the one message satisfies a predetermined condition into a same cluster.

For example, the clustering unit 21 may use, as similarity between two messages, a value (a degree of similarity) based on a ratio of the number of fields matched between the two messages to the number of fields that form each of the messages. In this case, a higher degree of similarity increases similarity between the two messages. For example, when each of two messages is formed of 10 fields and seven of the fields match, a degree of similarity between these messages is calculated to be 7/10=0.7. In this case, the clustering unit 21 may classify one message and each of the other messages whose degree of similarity to the one message is greater than or equal to a threshold value into a same cluster.

Alternatively, the clustering unit 21 may use, as similarity between two messages, a value (a distance) based on a ratio of the number of fields that do not match to the number of fields that form each of the messages. In this case, a greater distance reduces similarity between the two messages. For example, when each of two messages is formed of 10 fields and three of the fields do not match, a distance between these messages is calculated to be 3/10=0.3. In this case, the clustering unit 21 may classify one message and each of the other messages whose distance to the one message is less than or equal to a threshold value into a same cluster.

Note that, when two messages are different in numbers of fields, whether either the greater number or the lower number of fields is adopted as a denominator for calculating the degree of similarity or the distance may be determined in advance. For example, it is assumed that the greater number of fields is determined to be adopted. At this time, it is assumed that a message formed of nine fields and a message formed of 10 fields have six equal fields. In this case, a degree of similarity between these messages is calculated to be 6/10=0.60 for the above-described calculation technique. Furthermore, a distance between these messages is calculated to be 4/10=0.40 for the above-described calculation technique.

The clustering unit 21 regards a portion that matches a predetermined field pattern in each of messages as a field similar to one another among the messages and classifies the message set into a cluster. Herein, the predetermined field pattern is a pattern of a value on which a portion that can be regarded as a similar field may take even when the value is different among the messages. Such a field pattern may be defined in advance. For example, a date, a date and time, or the like can be regarded as a similar field even when a value is different. Thus, the clustering unit 21 may store a field pattern that matches a date format and a date and time format in advance. Then, the clustering unit 21 may calculate the above-described degree of similarity and distance by regarding a portion that matches the field pattern as a matching field even when a value is different.

The cluster similarity determination unit 24 determines, for each of clusters, whether or not similarity of the whole message group in the cluster satisfies a predetermined condition. Hereinafter, the similarity of the whole message group in the cluster is also simply described as the whole similarity. For example, the cluster similarity determination unit 24 may use, as the whole similarity, a ratio of fields that each form an invariable portion to fields that form a message group in a cluster. In this case, the predetermined condition may be a condition in which a value indicating the whole similarity is greater than or equal to a threshold value. The threshold value of the value indicating the whole similarity may be the same value as the threshold value of the degree of similarity used for judging similarity between two messages by the clustering unit 21.

Specifically, the cluster similarity determination unit 24 may calculate a value in which the number of fields that each form an invariable portion in a cluster is divided by the maximum number of fields among messages in the cluster as the value indicating the whole similarity. In this case, the cluster similarity determination unit 24 then determines whether or not the value indicating the whole similarity is greater than or equal to the threshold value.

Herein, even when a cluster is generated by the clustering unit 21 based on the threshold value of the degree of similarity or the distance, the whole similarity may not satisfy the predetermined condition in some cases. The reason is that a variable field greatly varies depending on each of the other messages determined to have similarity to a reference message for classification. Such a cluster is not often suitable for classification to generate a message pattern. Thus, the cluster similarity determination unit 24 is a functional block provided for excluding a cluster that is not suitable as a target to generate a message pattern.

Note that, even when there is a cluster determined by the cluster similarity determination unit 24 that the whole similarity does not satisfy the predetermined condition, the pattern generation unit 23 described below may perform processing with the other cluster, as a target, determined that the whole similarity satisfies the predetermined condition. Alternatively, when there is a cluster determined by the cluster similarity determination unit 24 that the whole similarity does not satisfy the predetermined condition, the clustering unit 21 may change the threshold value of the degree of similarity and perform clustering processing again.

In this case, examples of a method for changing a threshold value include a method for raising (increasing) a threshold value and a method for lowering (reducing) a threshold value. For example, when a threshold value concerned with a degree of similarity is raised, many fine clusters close to the number of messages that are actually output are obtained. In other words, the number of message patterns that are eventually obtained gets closer to the number of messages. When a threshold value concerned with a degree of similarity is lowered, rough clusters less than the number of messages that are actually output are obtained. In other words, the number of message patterns that are eventually obtained is less than the number of messages. The method for changing a threshold value may be decided according to uses of message patterns, an amount of messages, the number of types of message patterns, or the like.

The pattern generation unit 23 generates a message pattern for the cluster determined by the cluster similarity determination unit 24 that the whole similarity satisfies the predetermined condition, similarly to the pattern generation unit 13 in the first example embodiment of the present invention.

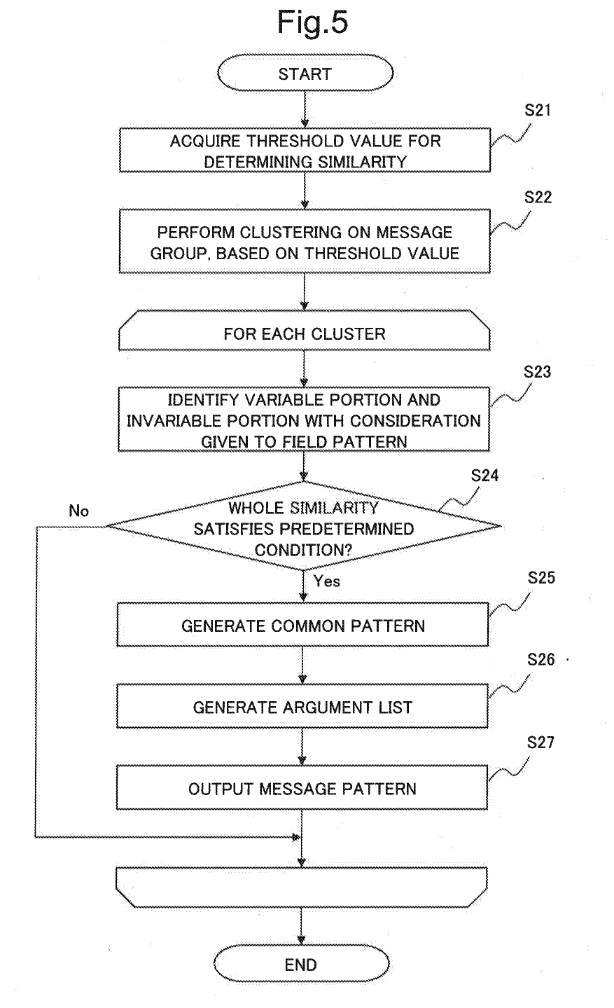

Operations of the message analysis apparatus 2 having the configuration as described above are described with reference to FIG. 5.

First, the clustering unit 21 acquires a threshold value for performing clustering on a message set (Step S21). For example, the clustering unit 21 may acquire a threshold value via the input device 1004.

Next, the clustering unit 21 classifies, in a target message set, one message and each of the other messages whose degree of similarity to the one message is greater than or equal to the threshold value or whose distance to the one message is less than or equal to the threshold value into a same cluster (Step S22).

Specifically, as described above, the clustering unit 21 takes out one message from an aggregation of messages, and calculates each degree of similarity (or distance) between the one message and each of the other messages. Then, the clustering unit 21 may only form one cluster by the taken-out message and each of the messages whose degree of similarity to the taken-out message is calculated to be greater than or equal to the threshold value (or whose distance to the taken-out message is calculated to be less than or equal to the threshold value).

Then, after calculating the one cluster, the clustering unit 21 performs similar processing on the rest of the messages that have not yet been classified to form the other cluster. The message analysis apparatus 2 then performs processing of Steps S23 to S27 on each cluster.

Note that the message analysis apparatus 2 may first classify all messages into any of clusters and repeatedly perform the processing of Steps S23 to S27 on each of the clusters. Alternatively, every time the message analysis apparatus 2 forms one cluster, the message analysis apparatus 2 may repeatedly perform the processing of Steps S23 to S27 on that cluster.

Herein, first, the field analysis unit 22 identifies, as an invariable portion, a field in which values of all messages in a cluster match and a field that matches a field pattern. The field analysis unit 22 identifies a field in which at least one message has a different value as a variable portion (Step S23).

Next, the cluster similarity determination unit 24 judges whether or not the whole similarity in this cluster satisfies a predetermined condition (Step S24).

As described above, the cluster similarity determination unit 24 may calculate a value in which the number of fields that each form the invariable portion in this cluster is divided by the maximum number of fields as a value indicating the whole similarity in the cluster. Then, the cluster similarity determination unit 24 may judge whether or not the value indicating the whole similarity in this cluster exceeds the threshold value.

When it is judged that the similarity in the whole cluster does not satisfy the predetermined condition, the message analysis apparatus 2 makes an output that the generation of a message pattern for the cluster fails, and ends processing.

On the other hand, when it is judged that the similarity in the whole cluster satisfies the predetermined condition, the pattern generation unit 23 generates a common pattern of this cluster (Step S25).

Specifically, the pattern generation unit 23 generates, as a common pattern, information in which information that expresses a field being the variable portion by a predetermined symbol (for example, an asterisk “*”) and information that indicates a field being the invariable portion are arranged in an appearing order of the fields. Note that the pattern generation unit 23 may generate, for a field of the invariable portion that matches a field pattern, the common pattern by using a predetermined character string instead of a value in the field. For example, the pattern generation unit 23 may generate a common pattern by indicating a field that matches a field pattern of a date as “(Date)” and indicating a field that matches a field pattern of time as “(Time)”.

Next, the pattern generation unit 23 generates an argument list of a field as the variable portion of the common pattern (Step S26).

The pattern generation unit 23 then outputs the common pattern and the argument list of each of the variable portions as a message pattern of this cluster (Step S27). Note that an output destination may be the other device connected via the output device 1003, the memory 1002, or a network.

Then, the message analysis apparatus 2 ends the operations.

Next, the operations of the message analysis apparatus 2 are illustrated as a specific example.

In this specific example, it is assumed that the message analysis apparatus 2 uses the degree of similarity described above for judging similarity among messages.

Herein, first, the clustering unit 21 acquires 0.6 as a threshold value of the degree of similarity (Step S21).

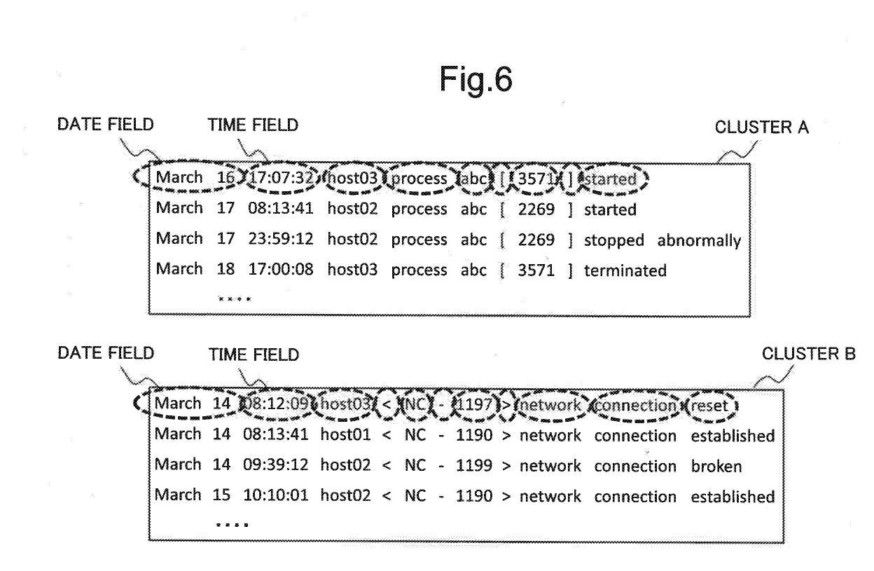

Next, the clustering unit 21 calculates the degree of similarity between one message and each of the other messages of a target log message group, and forms a cluster A and a cluster B as illustrated in FIG. 6 (Step S22).

In FIG. 6, each row indicates one message. An ellipse by a dotted line indicates a field. In this example, field patterns that indicate a date and a time are determined. The clustering unit 21 regards a portion that matches a field pattern of a date as a date field that matches among messages. The clustering unit 21 regards a portion that matches a field pattern of a time as a time field that matches among messages. In this case, in the cluster A, seven of nine fields match in messages in the first and second rows. Therefore, the clustering unit 21 calculates 7/9≠0.77 as the degree of similarity between the messages in the first and second rows. In this way, the clustering unit 21 classifies the message in the first row and each of the messages in the second to fourth rows whose degree of similarity to the message in the first row is greater than or equal to 0.6 into the cluster A. The same applies to the cluster B.

Next, the message analysis apparatus 2 performs the processing of Steps S23 to S27 on the cluster A.

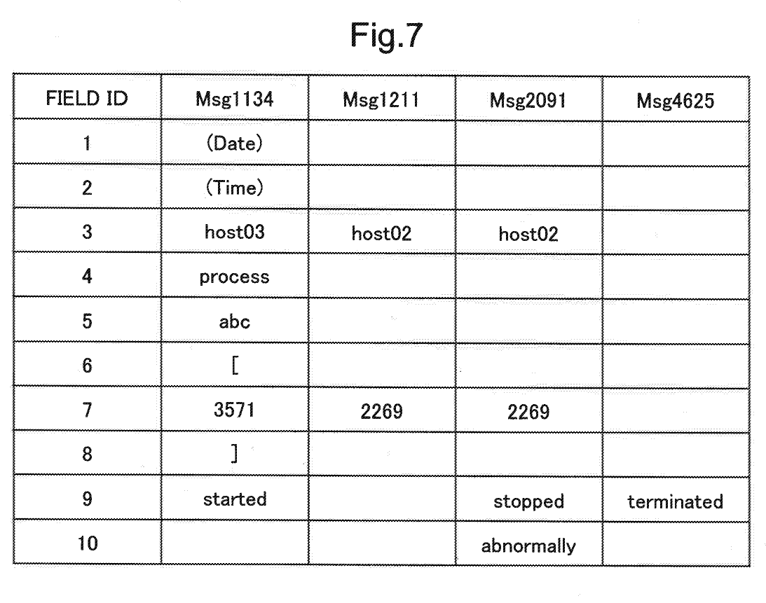

Herein, the field analysis unit 22 identifies a field as the invariable portion and a field as the variable portion in the cluster A, and generates an identification processing result as illustrated in FIG. 7 (Step S23).

In FIG. 7, the field analysis unit 22 first creates a table in which the identification processing result is stored. The table in which the identification processing result is stored includes an ID provided to a field in the first column (the leftmost column). This table includes identification information of a message in the first row (the uppermost row). In this table, an analytical result of each message can be stored in each column from the second column and following columns.

Next, the field analysis unit 22 performs identification processing with one of the messages (Msg 1134 as an example) included in the cluster A as a representative message. First, the field analysis unit 22 stores a value in each of fields that form the representative message Msg 1134 in the second column of the table in FIG. 7. However, the field analysis unit 22 stores information “(Date)” indicating a date, instead of a value, in the date field that matches the field pattern of the date. Furthermore, the field analysis unit 22 stores information “(Time)” indicating a time, instead of a value, in the time field that matches the field pattern of the time.

Next, the field analysis unit 22 stores, in the third column, a value in a field, which is different from the value of the representative message, among values in fields that each form a next message Msg 1211 included in the cluster A. However, the field analysis unit 22 does not store values in the date field and the time field on the assumption that the values match the values of the representative message. Then, the field analysis unit 22 also similarly stores, in the fourth and fifth columns, values in fields, which are different from the value of the representative message, of the rest of the messages Msg 2091 and Msg 4625 in the cluster A. In this way, the field analysis unit 22 performs the processing of storing values of all the messages in the cluster A in the table and generates the table in FIG. 7.

Next, the field analysis unit 22 identifies four fields (field IDs 3, 7, 9, 10) in which values are stored in at least one column from the third column and following columns in the table in FIG. 7 as variable portions of the cluster A. The field analysis unit 22 identifies six fields (field IDs 1, 2, 4, 5, 6, 8) in which values are not stored in the third column and following columns in the table in FIG. 7 as invariable portions of the cluster A.

Next, the cluster similarity determination unit 24 judges whether or not a value indicating the whole similarity in the cluster A is greater than or equal to the threshold value (Step S24).

With reference to FIG. 7, the maximum number of fields that form Msg 2091 is 10 in the cluster A. In Step S23, the six fields (field IDs 1, 2, 4, 5, 6, 8) are identified as the invariable portions of the cluster A. Therefore, the cluster similarity determination unit 24 calculates 6/10=0.60 as the value indicating the whole similarity in the cluster A. Herein, the threshold value is 0.6, so that the cluster similarity determination unit 24 judges that the value indicating the whole similarity in the cluster A is greater than or equal to the threshold value.

The pattern generation unit 23 expresses the field IDs 1, 2, 4, 5, 6, 8 being the invariable portions by their values or information indicating a field pattern in order to generate a common pattern of the cluster A. Furthermore, the pattern generation unit 23 expresses the field IDs 3, 7, 9, 10 being the variable portions by a predetermined symbol “*”. Then, the pattern generation unit 23 arranges these pieces of information in the order of the field IDs and generates the common pattern “(Date) (Time)*process abc [*] * *” of the cluster A (Step S25).

Next, the pattern generation unit 23 generates an argument list of each of the field IDs 3, 7, 9, 10 as the variable portions in the common pattern of the cluster A (Step S26).

For example, the pattern generation unit 23 generates an argument list “host01, host02, host03” of the field ID 3 with reference to the row of the field ID 3 in the table in FIG. 7. Similarly, the pattern generation unit 23 generates an argument list with reference to each of rows of the field IDs 7, 9, 10 in the table in FIG. 7.

The pattern generation unit 23 then outputs the common pattern of the cluster A and the argument list of each of the variable portions as a message pattern (Step S27).

The message analysis apparatus 2 also executes Steps S23 to S27 on the cluster B.

This is the end of the description of the specific example.

Next, advantageous effects of the second example embodiment of the present invention are described.

The message analysis apparatus according to the second example embodiment of the present invention can present a large quantity of messages as an aggregation of fewer message patterns and can support a user such that the user can more quickly grasp contents and trends of the messages.

The reasons are described as follows. In the present example embodiment, it is because the clustering unit regards portions that match a predetermined field pattern in messages as similar fields and performs clustering. Furthermore, it is because the field analysis unit regards portions that match the predetermined field pattern as invariable portions and generates a common message.

In this way, the present example embodiment can regard a slight difference among a plurality of messages as a similarity and can generate fewer common message patterns compared to the case in which a slight difference is regarded as a variable portion.

The other reasons are described as follows. In the present example embodiment, the cluster similarity determination unit judges whether or not the whole similarity in a cluster satisfies a predetermined condition. The pattern generation unit then generates a message pattern for a cluster in which the whole similarity satisfies the predetermined condition.

In this way, the present example embodiment generates a message pattern for a cluster in which the whole similarity is appropriate, so that the present example embodiment can present a message pattern that reflects contents and trends of a message group more accurately.

### Third Example Embodiment

Next, a third example embodiment of the present invention is described in detail with reference to the drawings. Note that the same configurations as those of the first and second example embodiments of the present invention and steps similarly operating to those thereof are denoted by the same signs in each of the drawings referred in description of the present example embodiment. Their detailed description in the present example embodiment is omitted.

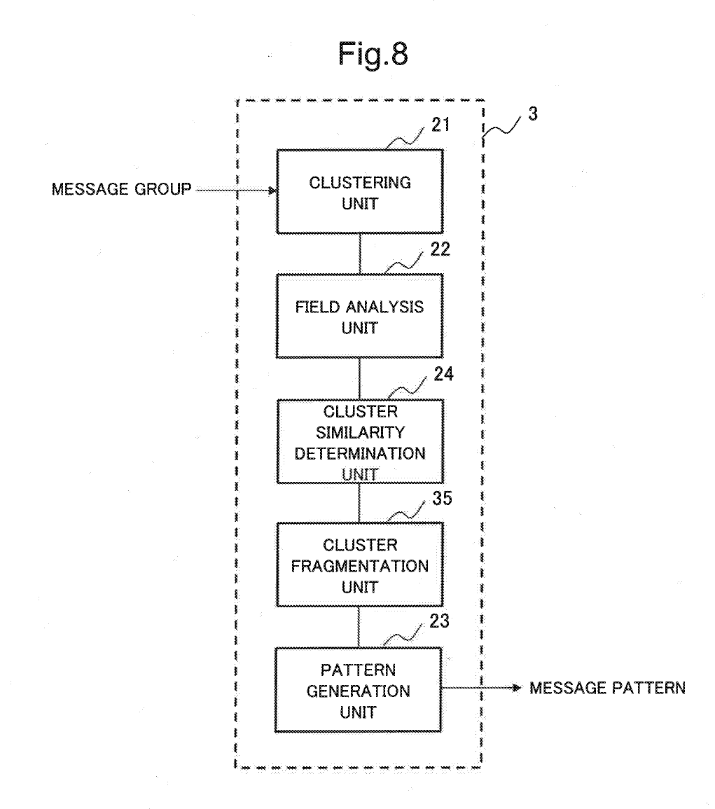

First, FIG. 8 illustrates a functional block configuration of a message analysis apparatus 3 according to the third example embodiment of the present invention. In FIG. 8, the message analysis apparatus 3 differs from the message analysis apparatus 2 according to the second example embodiment of the present invention in that the message analysis apparatus 3 further includes a cluster fragmentation unit 35. Note that the message analysis apparatus 3 and each of functional blocks of the message analysis apparatus 3 can be formed by the same hardware component as that of the first example embodiment of the present invention described with reference to FIG. 2. However, the hardware configurations of the message analysis apparatus 3 and each of the functional blocks are not limited to the above-described configuration.

The cluster fragmentation unit 35 generates clusters formed by further dividing a message group in a cluster generated by the clustering unit 21, based on importance of a variable portion. At this time, the cluster fragmentation unit 35 determines the importance of the variable portion, based on a part of speech of a value in a field that forms the variable portion. In detail, when a value in a field that forms the variable portion as a character string is a predetermined part of speech, the cluster fragmentation unit 35 regards the field as important and fragments the cluster, based on a difference of the value.

Specifically, the cluster fragmentation unit 35 specifies a field in which a value varies in at least one message in the cluster. The cluster fragmentation unit 35 then determines the importance of the field, based on whether or not the part of speech of the value in the specified field as a character string is a predetermined part of speech. Note that the cluster fragmentation unit 35 may determine the part of speech in the specified field, based on a value in any of messages (such as a representative message) in the cluster. The cluster fragmentation unit 35 may determine the part of speech with a dictionary in which parts of speech of character strings (words) are stored. Such a dictionary may be stored in, for example, the memory 1002 in advance. For example, a verb, an adverb, an adjective, or the like may be determined as the predetermined part of speech.

Note that, of fields identified as variable portions in a cluster before division, a field determined as important by fragmentation of the cluster is identified as an invariable portion in the cluster after the division.

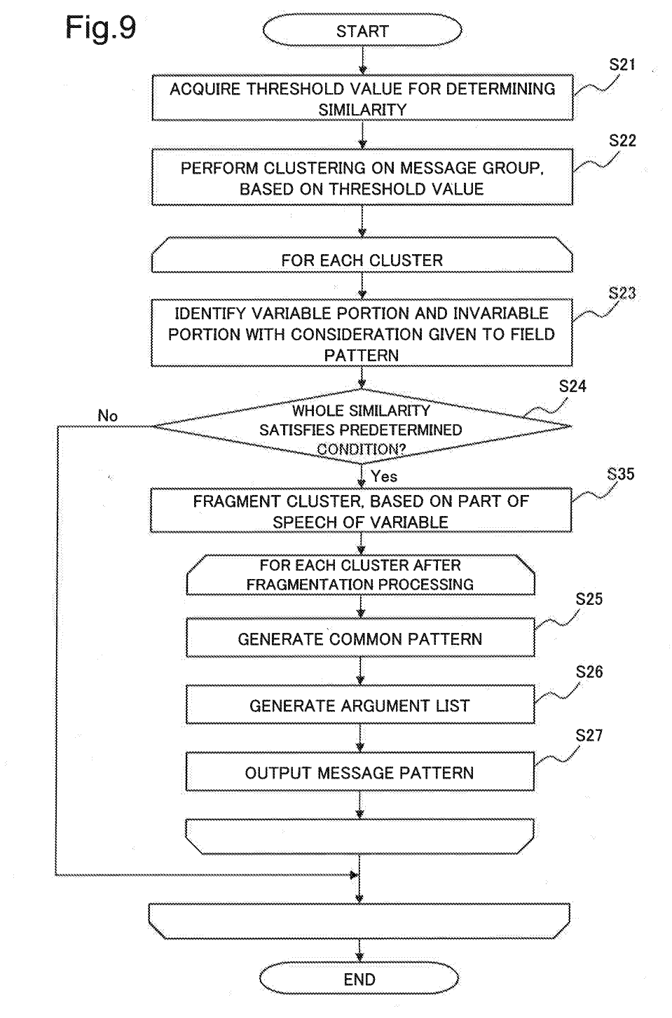

Operations of the message analysis apparatus 3 having the configuration as described above are described with reference to FIG. 9.

First, the message analysis apparatus 3 operates Steps S21 to S24 similarly to the second example embodiment of the present invention. The message analysis apparatus 3 analyzes fields of formed clusters and determines whether or not the whole similarity satisfies a predetermined condition.

Herein, the cluster fragmentation unit 35 further fragments a cluster determined that the whole similarity satisfies the predetermined condition, based on a part of speech of a value in a field as a variable portion (Step S35).

Specifically, as described above, the cluster fragmentation unit 35 determines a field as important when a value in the field that forms a variable portion is a character string and a predetermined part of speech. The cluster fragmentation unit 35 then fragments the cluster, based on a difference of the value in the field.

Next, the pattern generation unit 23 executes Steps S25 to S27 on each of clusters that have been fragmented and clusters that have not been fragmented, similarly to the second example embodiment of the present invention. However, for the fragmented clusters, the pattern generation unit 23 includes a value in the field that serves as reference for the fragmentation, as an invariable portion in a common pattern. In this way, the pattern generation unit 23 generates the common pattern and an argument list of a variable portion of the common pattern as a message pattern for each of the clusters that have been fragmented as necessary. The pattern generation unit 23 then outputs the message pattern.

Then, the message analysis apparatus 3 ends the operations.

Next, the operations of the message analysis apparatus 3 are illustrated as a specific example.

Herein, it is assumed that the cluster A and the cluster B illustrated in FIG. 6 have been generated by the clustering unit 21 and a field analytical result of the cluster A illustrated in FIG. 7 has been generated (Steps S21 to S24).

Next, the cluster fragmentation unit 35 fragments a cluster (Step S35).

Specifically, the cluster fragmentation unit 35 first determines that a value “started” of the field ID 9 in the representative message Msg 1134 is a predetermined part of speech (verb) among the field IDs 3, 7, 9, 10 as the variable portions in FIG. 7. In other words, the cluster fragmentation unit 35 determines the field ID 9 as an important field that varies.

On the other hand, the cluster fragmentation unit 35 determines that a value “host03” of the field ID 3 and a value “3571” of the field ID 7 in the representative message Msg 1134 are not any predetermined part of speech (verb, adverb, and adjective). In other words, the cluster fragmentation unit 35 determines the field ID 3 and the field ID 7 as auxiliary fields that vary.

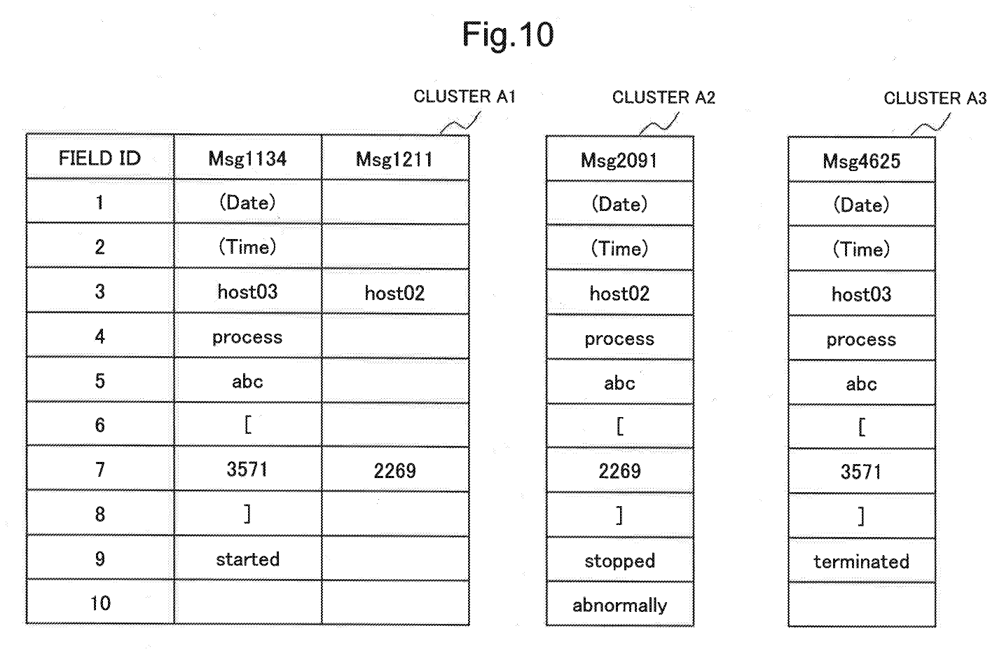

Thus, the cluster fragmentation unit 35 fragments the cluster A, based on the value of the field ID 9 as the important field. FIG. 10 illustrates clusters A1 to A3 formed by fragmenting the cluster A. As illustrated in FIG. 10, the cluster fragmentation unit 35 classifies, into the cluster A1, Msg 1134 and Msg 1121 in which the value of the field ID 9 is “started” among the message group included in the cluster A. The cluster fragmentation unit 35 classifies Msg 2091 in which the value of the field ID 9 is “stopped” into the cluster A2. The cluster fragmentation unit 35 classifies Msg 4625 in which the value of the field ID 9 is “terminated” into the cluster A3.

Similarly, it is assumed that the cluster fragmentation unit 35 also divides the cluster B, based on a part of speech of a value in a field as a variable portion, and generates fragmented n clusters B1 to Bn (where n is an integer of greater than or equal to 1).

Next, the pattern generation unit 23 generates a message pattern for the clusters A1 to A3 and the clusters B1 to Bn that have been fragmented (Steps S25 to S27).

For example, a common pattern “(Date) (Time)*process abc [*] started” is generated for the cluster A1. Furthermore, an argument list “host03, host 02” of the field ID 3 as the variable portion and an argument list “3571, 2269” of the field ID 7 as the variable portion are generated for the cluster A1.

A common pattern “(Date) (Time) host02 process abc [2269] stopped abnormally” is generated for the cluster A2.

A common pattern “(Date) (Time) host03 process abc [3571] terminated” is generated for the cluster A3.

In this way, the pattern generation unit 23 includes the value of the field ID 9 that serves as the reference for the division, as the invariable portion in the clusters A1 to A3 in the common pattern. Also in this example, the cluster A2 and the cluster A3 each have the same values in the field IDs 3, 7, and 10, which are the variable portions in the cluster A before the division. Thus, the pattern generation unit 23 includes the values of the field IDs 3, 7, and 10 in the common patterns of the cluster A2 and the cluster A3. However, the pattern generation unit 23 generates a common pattern such that a field as a variable portion, which is determined as unimportant by the cluster fragmentation unit 35, is assumed to be a variable portion when a value in a cluster after division does not match a value before the division.

Similarly, the pattern generation unit 23 also generates the message pattern for the clusters B1 to Bn.

This is the end of the description of the specific example.

Next, advantageous effects of the third example embodiment of the present invention are described.

The message analysis apparatus according to the third example embodiment of the present invention allows a user to more accurately grasp contents and trends of important information in messages when presenting a large quantity of messages as an aggregation of fewer message patterns.

The reasons are described as follows. In the present example embodiment, it is because the cluster fragmentation unit further fragments a message group included in a cluster, based on importance of a field as a variable portion, in addition to the similar configuration to that of the second example embodiment of the present invention. It is because the pattern generation unit then generates a message pattern for the fragmented cluster.

In this way, the present example embodiment explicitly includes a value of an important variable portion in a message pattern, and does not include a value of an auxiliary variable portion in the message pattern. In other words, the present example embodiment can distinguish between main information and auxiliary information of portions that vary. As a result, the present example embodiment can reflect a value of the main information as it is in a message pattern even when the main information is a portion that varies.

Furthermore, the message analysis apparatus according to the third example embodiment of the present invention allows a user to more accurately grasp contents and trends of behavior, a status, or the like of a system when presenting a large quantity of messages output from the system as an aggregation of fewer message patterns.

Herein, an analyzer who analyzes a large quantity of message groups recorded by the system needs to assume what is happening in the system from the message groups. However, when a portion in a field indicating behavior and a status of the system is recognized as a variable, a value of the portion does not appear in a message pattern. For example, a portion of a part of speech such as a verb, an adverb, and an adjective in a message is more likely to indicate operations or a status of the system and have an important meaning. When a value of such a portion is not included in the message pattern, it is more difficult for the analyzer to grasp the operations and the status of the system.

When a value in a field as a variable portion in a message is a predetermined part of speech (verb, adverb, adjective, etc.), the present example embodiment fragments a cluster, based on the value in the field. In this way, the present example embodiment reflects important information indicating operations, a status, or the like of a system in a message as it is in a message pattern. As a result, the analyzer who uses the present example embodiment can correctly grasp the important information about the behavior, the status, or the like of the system that is an output source of the message group, based on the message pattern.

### Fourth Example Embodiment

Next, a fourth example embodiment of the present invention is described in detail with reference to drawings. Note that the same configurations as those of the first to third example embodiments of the present invention and steps similarly operating to those thereof are denoted by the same signs in each drawing referred in description of the present example embodiment. Their detailed description in the present example embodiment is omitted.

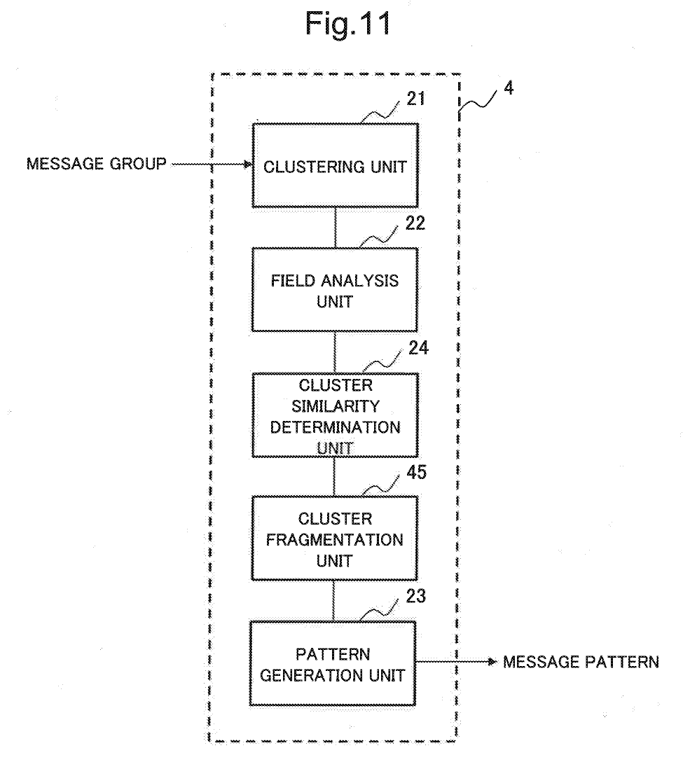

First, FIG. 11 illustrates a functional block configuration of a message analysis apparatus 4 according to the fourth example embodiment of the present invention. In FIG. 11, the message analysis apparatus 4 differs from the message analysis apparatus 3 according to the third example embodiment of the present invention in that the message analysis apparatus 4 includes a cluster fragmentation unit 45 instead of the cluster fragmentation unit 35.

The cluster fragmentation unit 45 substantially similar to the cluster fragmentation unit 35 in the third example embodiment of the present invention generates a cluster formed by further dividing a message group in a cluster generated by the clustering unit 21, based on importance of a variable portion. However, the cluster fragmentation unit 45 differs from the cluster fragmentation unit 35 in the third example embodiment of the present invention in that the cluster fragmentation unit 45 determines importance of a variable portion, based on correlations among fields that each form the variable portion.

In detail, in a case of the presence of correlations among a plurality of fields that form variable portions, the cluster fragmentation unit 45 regards these fields as important and fragments a cluster, based on a difference of their values.

Specifically, the cluster fragmentation unit 45 specifies a field in which a value varies in at least one message in the cluster. The cluster fragmentation unit 45 then analyzes a combination of the fields that vary for a co-occurrence relation between arguments. The presence of the co-occurrence relation indicates that a value (argument) of one variable (field) and a value of the other variable appear in one message at the same time.

When the value of the one variable and the value of the other variable have a one-to-one correspondence in a message group of its cluster, the cluster fragmentation unit 45 may determine that there are correlations between the respective fields. The cluster fragmentation unit 45 may calculate a probability of co-occurrence between the arguments in a combination of the fields that form the variable portions. In this case, when the probability of co-occurrence between the arguments is significantly higher than a random probability (for example, greater than or equal to a threshold value), the cluster fragmentation unit 45 may determine that there are correlations between the fields.

The cluster fragmentation unit 45 regards each of the fields determined to have the correlations as important and fragments the cluster, based on their values.

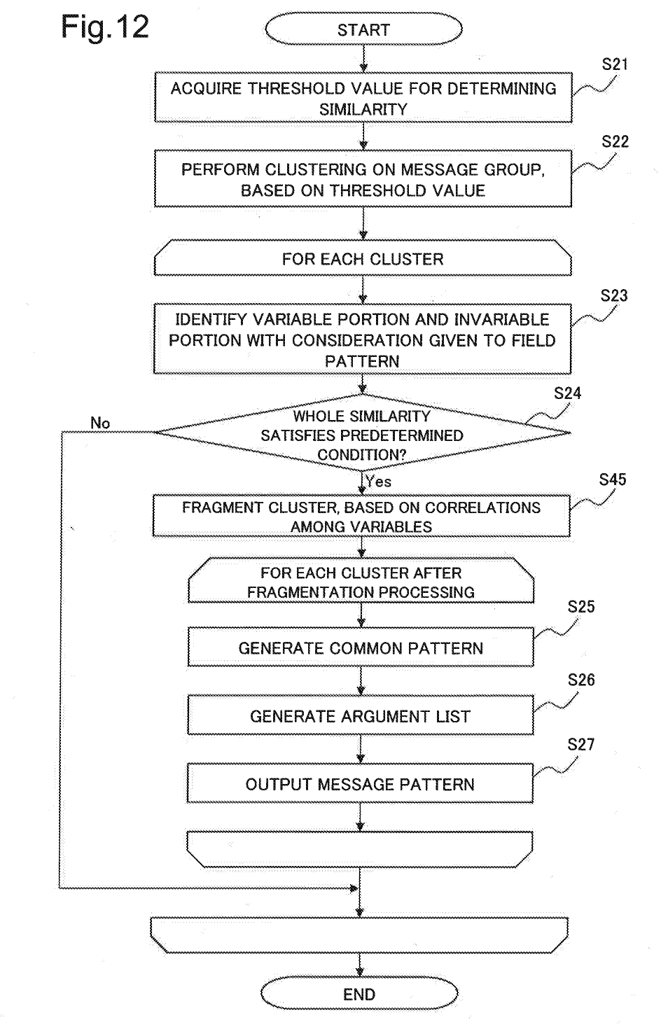

Operations of the message analysis apparatus 4 having the configuration as described above are described with reference to FIG. 12.

First, the message analysis apparatus 4 operates Steps S21 to S24 similarly to the second example embodiment of the present invention. The message analysis apparatus 4 analyzes fields of formed clusters and determines whether or not the whole similarity satisfies a predetermined condition.

Next, the cluster fragmentation unit 45 further fragments a cluster determined that the whole similarity satisfies the predetermined condition, based on the presence or absence of correlations among a plurality of fields that form variable portions (Step S45).

Specifically, as described above, when arguments in a combination of the plurality of fields that form the variable portions have a one-to-one correspondence (or a probability of co-occurrence between the arguments is greater than or equal to a threshold value), the cluster fragmentation unit 45 determines the fields as important. The cluster fragmentation unit 45 then fragments the cluster, based on a difference of the values in their fields.

Next, the message analysis apparatus 4 executes Steps S25 to S27 similarly to the third example embodiment of the present invention. In this way, the pattern generation unit 23 generates the common pattern and an argument list of a variable portion of the common pattern as a message pattern for each of the clusters that have been fragmented as necessary. The pattern generation unit 23 then outputs the message pattern.

Then, the message analysis apparatus 4 ends the operations.

Next, operations of the message analysis apparatus 4 are illustrated as a specific example.

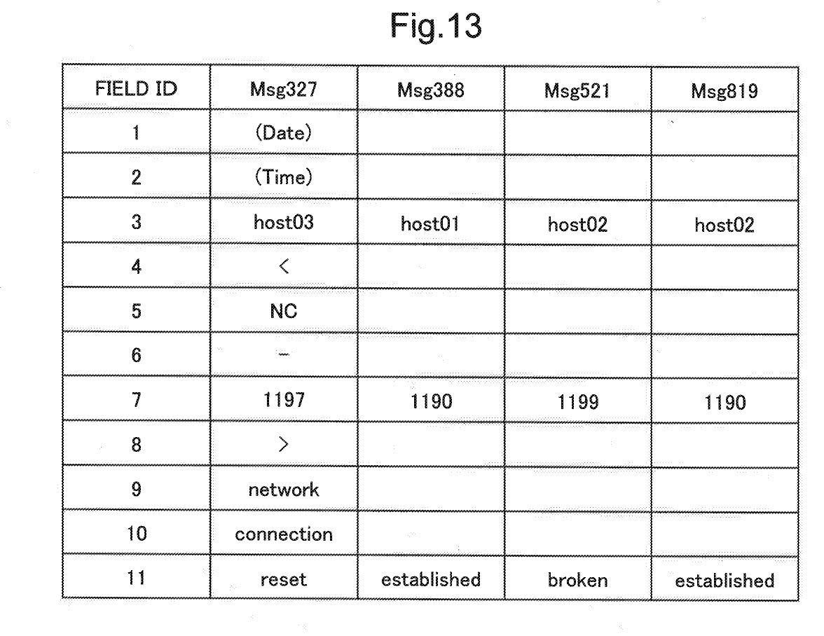

Herein, it is assumed that the cluster A and the cluster B illustrated in FIG. 6 have been generated by the clustering unit 21 and a field analytical result of the cluster B illustrated in FIG. 13 has been generated (Steps S21 to S24).

Next, the cluster fragmentation unit 45 fragments a cluster, based on correlations among fields.

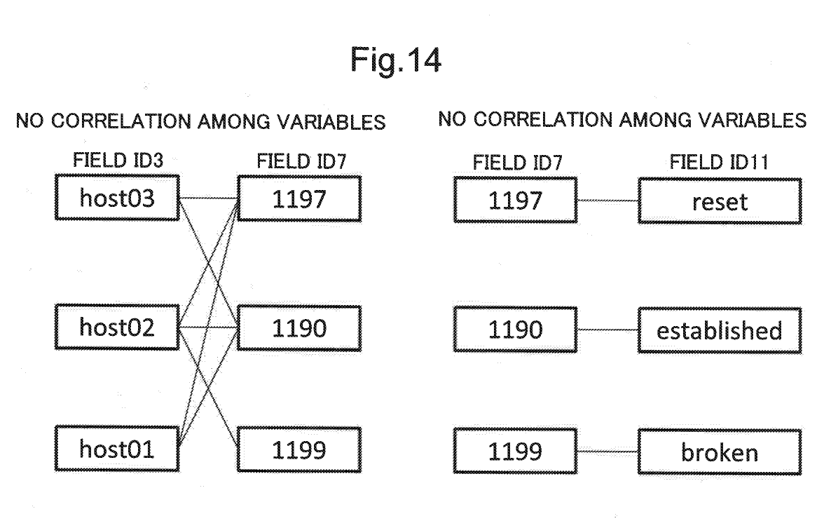

Specifically, the cluster fragmentation unit 45 first analyzes a combination of the field IDs 3, 7, 11, which are variable portions in the cluster B, for a co-occurrence relation of arguments. FIG. 14 schematically illustrates an analytical result of the co-occurrence relation. In FIG. 14, the left diagram illustrates the co-occurrence relation of arguments between the field IDs 3 and 7. The right diagram illustrates the co-occurrence relation of arguments between the field IDs 7 and 11. In FIG. 14, a rectangle indicates a value in each of the fields therein. A line connecting the rectangles expresses the co-occurrence relation.

As illustrated in FIG. 14, regularity is not seen in the way of appearance of the values between the field IDs 3 and 7. On the other hand, the values between the field IDs 7 and 11 have a one-to-one correspondence. In other words, the probability of co-occurrence between the arguments is 100% between the field IDs 7 and 11.

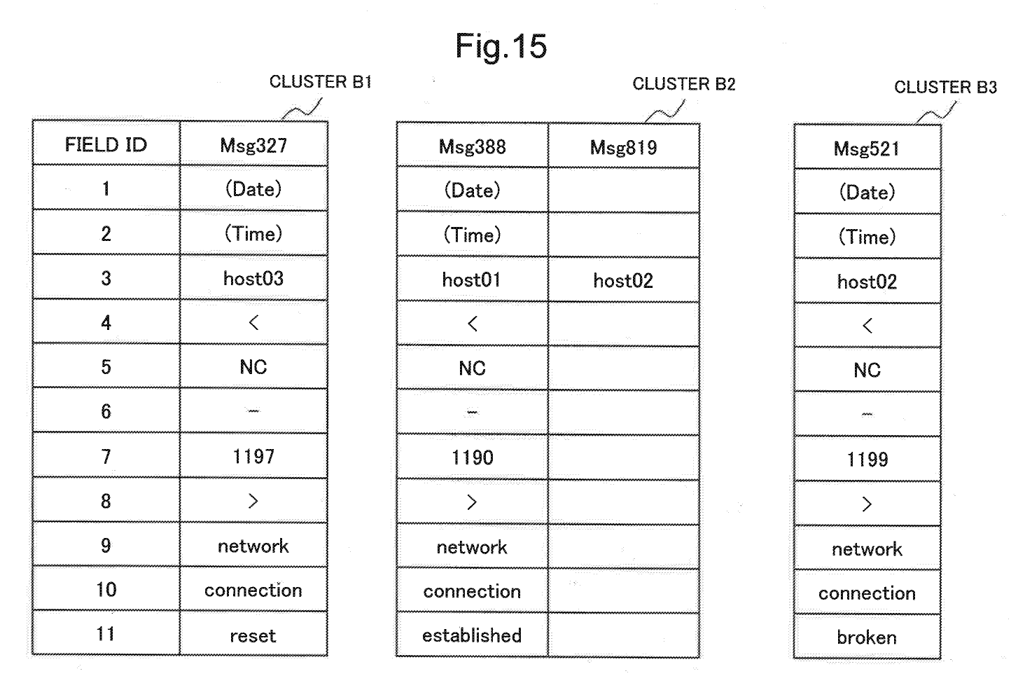

In this case, the cluster fragmentation unit 45 considers that there is the correlation between the field IDs 7 and 11 in which the probability of co-occurrence between the arguments is 100%. In this way, the cluster fragmentation unit 45 determines the field IDs 7 and 11 having the correlation as important fields. The cluster fragmentation unit 45 then fragments the cluster B, based on values (arguments) of the field IDs 7 and 11. FIG. 15 illustrates clusters B1 to B3 formed by fragmenting the cluster B. As illustrated in FIG. 15, the cluster fragmentation unit 45 classifies, into the cluster B1, Msg 327 in which a combination of values of the field IDs 7 and 11 is “1197” and “reset” in the message group included in the cluster B. The cluster fragmentation unit 45 classifies, into the cluster B2, Msg 388 and Msg 819 in which a combination of values of the field IDs 7 and 11 is “1190” and “established”. The cluster fragmentation unit 45 classifies, into the cluster B3, Msg 521 in which a combination of values of the field IDs 7 and 11 is “1199” and “broken”.

Similarly, it is assumed that the cluster fragmentation unit 45 also divides the cluster A, based on correlations among fields as variable portions, and generates fragmented m clusters A1 to Am (where m is an integer of greater than or equal to 1).

Next, the pattern generation unit 23 generates a message pattern for the clusters A1 to Am and the clusters B1 to B3 that have been fragmented (Steps S25 to S27).

For example, a common pattern “(Date) (Time) host03<NC-1197>network connection reset” is generated for the cluster B1.

A common pattern “(Date) (Time)*<NC-1190>network connection established” is generated for the cluster B2. Furthermore, an argument list “host01, host02” of the field ID 3 as the variable portion is generated for the cluster B2.

A common pattern “(Date) (Time) host02<NC-1199>network connection broken” is generated for the cluster B3.

In this way, the pattern generation unit 23 includes, as the invariable portions, the values in the field IDs 7 and 11 that serve as the reference for the division, in the clusters B1 to B3 in the common patterns. Also in this example, the clusters B1 and B3 each have the same value in the field ID 3, which is the variable portion in the cluster B before the division. Thus, the pattern generation unit 23 includes the value of the field ID 3 in the common patterns of the clusters B1 and B3. However, the pattern generation unit 23 generates a common pattern such that a field as a variable portion, which is determined as unimportant by the cluster fragmentation unit 45, is assumed to be a variable portion when a value in a cluster after division does not match a value before the division.

Similarly, the pattern generation unit 23 also generates the message pattern for the clusters A1 to Am.

This is the end of the description of the specific example.

Next, advantageous effects of the fourth example embodiment of the present invention are described.

The message analysis apparatus according to the fourth example embodiment of the present invention allows a user to accurately grasp contents and trends of information indicating an intention of a designer of messages when presenting a large quantity of messages as an aggregation of fewer message patterns.

The reasons are described as follows. In the present example embodiment, it is because the cluster fragmentation unit further fragments a message group included in a cluster, based on the presence or absence of correlations among fields as variable portions, in addition to the similar configuration to that of the second example embodiment of the present invention. It is because the pattern generation unit then generates a message pattern for the fragmented cluster.

In this way, the present example embodiment explicitly includes values of variable portions having correlations in a message pattern. In other words, the present example embodiment can distinguish between main information, which is the variable portion having the correlation, and auxiliary information, which is not the variable portion having the correlation, among portions that vary. As a result, the present example embodiment can reflect a value of the main information having the correlation among the variables as it is in a message pattern even when the main information is a portion that varies.

Herein, the values of such variables (fields) having the correlations are more likely to be information previously designed by a designer of messages for some intentions. For example, the designer of the messages conceivably designs a log output by a system such that an error code indicating a type of an error message and an error level indicating a degree of severity of the error message are included together in the messages. In such messages, there are correlations among fields each indicating the error code and the error level.

In this way, the present example embodiment can reflect important information intended by the designer of the messages in a message pattern by analyzing the presence or absence of the correlations among the fields as the variable portions. As a result, the analyzer of the messages who uses the present example embodiment can grasp the intention of the designer of the messages from the message pattern.

Note that the example in which the cluster fragmentation unit fragments a cluster, based on a part of speech of a value in a field that forms a variable portion or based on the presence or absence of correlations among fields is described in the third and fourth example embodiments of the present invention described above. This is not restrictive. The cluster fragmentation unit may determine importance of a field that forms a variable portion, based on the other information, and fragment a cluster, based on a value in a field determined to have importance.

In each of the example embodiments of the present invention described above, the example in which a message is text information output by a component in the IT system is mainly described. The message may be information output by the other component. The message may be information input via the input device. The message may include information of types other than text.

In each of the example embodiments of the present invention described above, the example in which the clustering unit performs clustering with a ratio of fields that match as a degree of similarity or with a ratio of fields that do not match as a distance is described. This is not restrictive. The clustering unit may calculate a degree of similarity or a distance, based on the other information that can be calculated as information indicating similarity among messages, and perform clustering.

In each of the example embodiments of the present invention described above, the example in which the pattern generation unit generates, as a common message, information in which information that expresses a value of a field being an invariable portion and information that expresses a field being a variable portion by a predetermined symbol are arranged in an appearing order of the fields is described. The example in which the pattern generation unit generates a list of arguments on which a field as a variable portion may take is also described. However, they do not limit an expression form of message patterns. The pattern generation unit may generate a message pattern in the other form as long as the expression form allows a value in a field forming an invariable portion and a value of an argument on which a field forming a variable portion takes to be recognized in a cluster.

In each of the example embodiments of the present invention described above, the example in which each of the functional blocks of the message analysis apparatus is achieved by the CPU that executes the computer program stored in the storage device or the ROM is mainly described. This is not restrictive. A part, the whole, or a combination of each of the functional blocks may be achieved by special hardware.

In each of the example embodiments of the present invention described above, the functional blocks of the message analysis apparatus may be achieved by being distributed in a plurality of devices.

In each of the example embodiments of the present invention described above, the operations of the message analysis apparatus described with reference to each of the flowcharts may be stored as the computer program of the present invention in a storage device (storage medium) of the computer. The CPU may read and execute such a computer program. In such a case, the present invention is formed by a code of such a computer program or the storage medium.

The example embodiments described above can be arbitrarily combined and performed.

### INDUSTRIAL APPLICABILITY

The present invention is suitable as an apparatus that can extract a common portion and a variable portion of a plurality of messages from a large quantity of messages without a need to define a variable portion in advance and that presents an analysis of contents and trends of the messages. The present invention is suitable as an apparatus that mechanically generates a definition of a message pattern as a filtering target in a log monitoring tool for filtering out logs that do not need to be notified in log monitoring operations in a system. The present invention is also suitable as an apparatus that supports work for extracting characteristic logs from a group of error messages that occur in large quantity in abnormal situations and analyzing them in log analyzing work when a system is abnormal. Further, the present invention is suitable as an apparatus that supports an analysis of trends of users, status grasping, or the like in a large quantity of messages written in a social networking service or the like on the Internet by users.

The present invention has been described with the above-described example embodiments as typical examples. However, the present invention is not limited to the above-described example embodiments. In other words, various aspects that a person skilled in the art can understand are applicable to the present invention within the scope of the present invention.

This application is based upon and claims the benefit of priority from Japanese Patent Application No. 2015-118217, filed on Jun. 11, 2015, the disclosure of which is incorporated herein in its entirety by reference.

### REFERENCE SIGNS LIST

1, 2, 3, 4 Message analysis apparatus
11, 21 Clustering unit
12, 22 Field analysis unit
13, 23 Pattern generation unit
24 Cluster similarity determination unit
35, 45 Cluster fragmentation unit
1001 CPU
1002 Memory
1003 Output device
1004 Input device

What is claimed is:

1. A message analysis apparatus comprising:
one or more processors forming clustering unit configured to classify a message set that is an aggregation of messages each being formed of one or more fields, into a cluster, based on similarity among the messages;
the one more processors forming field analysis unit configured to identify, in each of fields that form a message group in the cluster, a variable portion in which a value in the field varies and an invariable portion in which a value in the field does not vary; and
the one more processors forming pattern generation unit configured to generate a message pattern being common to the message group in the cluster, based on the variable portion and the invariable portion.

2. The message analysis apparatus according to claim 1, further comprising
the one more processors forming cluster fragmentation unit configured to generate a cluster by further dividing the cluster, based on importance of the variable portion.

3. The message analysis apparatus according to claim 2, wherein
the cluster fragmentation means determines importance of the variable portion, based on a part of speech of a value in a field that forms the variable portion.

4. The message analysis apparatus according to claim 2, wherein
the cluster fragmentation means determines importance of the variable portion, based on a correlation among fields that each form the variable portion.

5. The message analysis apparatus according to claim 1, wherein
the clustering means classifies the message and another message whose similarity to the message satisfies a predetermined condition into a same cluster.

6. The message analysis apparatus according to claim 1, further comprising
cluster similarity determination means that determines whether or not whole similarity of a message group in the cluster satisfies a predetermined condition, wherein
the pattern generation means generates the message pattern for a cluster determined by the cluster similarity determination means that the whole similarity satisfies a predetermined condition.

7. The message analysis apparatus according to claim 1, wherein
the clustering means regards a portion that matches a predetermined field pattern in each of the messages as a field similar to one another among the messages and classifies the message group into the cluster, and
the field analysis means identifies a field having a value that matches the field pattern, as an invariable portion.

8. A message analysis method by using a computer device, comprising:
classifying a message set that is an aggregation of messages each being formed of one or more fields, into a cluster, based on similarity among the messages;
identifying, in each of fields that form a message group in the cluster, a variable portion in which a value in the field varies and an invariable portion in which a value in the field does not vary; and
generating a message pattern being common to the message group in the cluster, based on the variable portion and the invariable portion.

9. A non-transitory computer readable storage medium that stores a message analysis program causing a computer device to execute:
classifying a message set that is an aggregation of messages each being formed of one or more fields, into a cluster, based on similarity among the messages;
identifying, in each of fields that form a message group in the cluster, a variable portion in which a value in the field varies and an invariable portion in which a value in the field does not vary; and
generating a message pattern being common to the message group in the cluster, based on the variable portion and the invariable portion.

10. The message analysis apparatus according to claim 2, wherein
the clustering means classifies the message and another message whose similarity to the message satisfies a predetermined condition into a same cluster.

11. The message analysis apparatus according to claim 3, wherein
the clustering means classifies the message and another message whose similarity to the message satisfies a predetermined condition into a same cluster.

12. The message analysis apparatus according to claim 4, wherein
the clustering means classifies the message and another message whose similarity to the message satisfies a predetermined condition into a same cluster.

13. The message analysis apparatus according to claim 2, further comprising
cluster similarity determination means that determines whether or not whole similarity of a message group in the cluster satisfies a predetermined condition, wherein
the pattern generation means generates the message pattern for a cluster determined by the cluster similarity determination means that the whole similarity satisfies a predetermined condition.

14. The message analysis apparatus according to claim 3, further comprising
cluster similarity determination means that determines whether or not whole similarity of a message group in the cluster satisfies a predetermined condition, wherein
the pattern generation means generates the message pattern for a cluster determined by the cluster similarity determination means that the whole similarity satisfies a predetermined condition.

15. The message analysis apparatus according to claim 4, further comprising
cluster similarity determination means that determines whether or not whole similarity of a message group in the cluster satisfies a predetermined condition, wherein
the pattern generation means generates the message pattern for a cluster determined by the cluster similarity determination means that the whole similarity satisfies a predetermined condition.

16. The message analysis apparatus according to claim 5, further comprising
cluster similarity determination means that determines whether or not whole similarity of a message group in the cluster satisfies a predetermined condition, wherein
the pattern generation means generates the message pattern for a cluster determined by the cluster similarity determination means that the whole similarity satisfies a predetermined condition.

17. The message analysis apparatus according to claim 2, wherein
the clustering means regards a portion that matches a predetermined field pattern in each of the messages as a field similar to one another among the messages and classifies the message group into the cluster, and
the field analysis means identifies a field having a value that matches the field pattern, as an invariable portion.

18. The message analysis apparatus according to claim 3, wherein
the clustering means regards a portion that matches a predetermined field pattern in each of the messages as a field similar to one another among the messages and classifies the message group into the cluster, and
the field analysis means identifies a field having a value that matches the field pattern, as an invariable portion.

19. The message analysis apparatus according to claim 4, wherein
the clustering means regards a portion that matches a predetermined field pattern in each of the messages as a field similar to one another among the messages and classifies the message group into the cluster, and
the field analysis means identifies a field having a value that matches the field pattern, as an invariable portion.

20. The message analysis apparatus according to claim 5, wherein
the clustering means regards a portion that matches a predetermined field pattern in each of the messages as a field similar to one another among the messages and classifies the message group into the cluster, and
the field analysis means identifies a field having a value that matches the field pattern, as an invariable portion.
